(19) United States
(12) Patent Application Publication
(10) Pub. No.: US 2017/0298603 A1
(43) Pub. Date: Oct. 19, 2017

(54) Dual Vertical Check Valve

(71) Applicant: AA Anti-Air-Lock Corp, Iselin, NJ (US)

(72) Inventor: MICHAEL ANTHONY DI MONTE, SR., CREAM RIDGE, NJ (US)

(21) Appl. No.: 15/299,446

(22) Filed: Oct. 20, 2016

Related U.S. Application Data
(63) Continuation-in-part of application No. 15/293,315, filed on Oct. 14, 2016, now Pat. No. 9,657,468.
Application No. 15/293,315 is a continuation-in-part of application No. 15/275,419, filed on Sep. 25, 2016.
Application No. 15/275,419 is a continuation-in-part of application No. 15/246,464, filed on Aug. 24, 2016.
Application No. 15/246,464 is a continuation-in-part of application No. 15/132,131, filed on Apr. 18, 2016.

(51) Int. Cl. E03C 1/122; F16K 27/02; F16K 15/04; B01D 46/00; B01D 46/42; G01L 7/16; F16K 15/14

(52) U.S. Cl. CPC E03C 1/1225; G01L 7/166; F16K 27/0209; F16K 15/144; B01D 46/0089; F16K 15/042; B01D 46/4272; F16K 15/048

(57) ABSTRACT

An apparatus to allow or stop a flow into an enclosed environment or piping system comprises: (a) a housing having an upper flow passage, a middle flow passage, a lower flow passage; (b) a first valve seat, wherein the first valve seat is between the upper flow passage and the middle flow passage, and wherein a first opening is formed on the first valve seat; (c) a first rotary valve inside the housing, moving inside the upper flow passage and above the first valve seat; (d) a second valve seat, wherein the second valve seat is between the middle flow passage and the lower flow passage, wherein a second opening is formed on the second valve seat; and (e) a second rotary valve inside the housing, moving inside the middle flow passage and above the second valve seat.

### CROSS-REFERENCE RELATED TO RELATED APPLICATIONS

This application is a continuation-in-part of commonly-owned, same inventor, presently co-pending U.S. Nonprovisional patent application Ser. No. 15,293,315, filed Oct. 14, 2016, which is incorporated herein by reference in its entirety. The co-pending Nonprovisional patent application Ser. No. 15,293,315 application is also a continuation-in-part of commonly-owned, same inventor, presently co-pending U.S. Nonprovisional patent application Ser. No. 15/275,419, filed Sep. 25, 2016, which is incorporated herein by reference in its entirety. The presently co-pending application Ser. No. 15/275,419 is a continuation-in-part of commonly-owned, same inventor, presently co-pending U.S. Nonprovisional patent application Ser. No. 15/246,464, filed Aug. 24, 2016, which is incorporated herein by reference in its entirety. The co-pending Nonprovisional patent application Ser. No. 15/246,464 application is also a continuation-in-part of commonly-owned, same inventor, presently co-pending U.S. Nonprovisional patent application Ser. No. 15/132,131, filed Apr. 18, 2016, which is incorporated herein by reference in its entirety. U.S. Nonprovisional patent application Ser. No. 15/132,131 also claims the priority and benefit of U.S. provisional patent application No. U.S. Provisional Application No. 62/151,463, filed Apr. 23, 2015.

### BACKGROUND

A variety of air admittance valves and check valves have been made over the years for allowing air to enter a piping system or an enclosed environment under a negative or vacuum pressure, which is created when water is flowing down the drain for instance thus to preventing siphoning of traps or when a sump pump keeps pumping water and air out of an enclosed sump pit. Attaching an air admittance valve or check valve allows ambient air to enter the enclosed environment to eliminate negative pressure or vacuum in the enclosed system. Many of these products are specifically or only designed for systems such as piping systems and sewer systems where a local vent or air intake is not possible or due to the difficulty of running pipes through an already built home. Typically, these air admittance valves or check valves only provide specific operating conditions such as the vacuum pressure in the amount of air required. The air admittance valves and check valves available in the market today do not provide for an instantaneous and higher volume of air demand. And this causes a problem when existing air admittance components are installed on systems requiring the higher airflow demand. This problem causes strain on the air admittance component and cause it to fail prematurely in addition it causes it to operate against its own design because it was designed to work on a natural gravity air flow vacuum or negative pressure constraint. Also it is a problem that the air admittance valves and check valves not working at all or failing immediately when a high airflow demand is required. Furthermore, another problem is that air admittance components available do not filter the air and therefore can allow for corrosive environment to enter the system and damaging the Air admittance components.

There is also an undesired negative situation that the piping system will generate a negative pressure in the piping system when the flow is drained from the piping system. When negative pressure occurs, the water seals in the U-band or trap will be syphoned out and losses the function to prevent sewer gas to enter the house. Therefore, various air admittance valves and check valves have designed to allow air enter a piping system to prevent the negative pressure environment. However, regular air admittance valve and check valve are also easy to fail.

For these reasons are users are disappointed when there is no product available on the market that they can use for a higher volume demand in a negative pressure scenario such as an enclosed pit with a pump requiring air to enter the system at the same rate of which it is pumping the water out. For instance, a pump that can pump 20 gallons per minute and would require a large demand of airflow to enter the system so that a vacuum does not occur putting stress on the pump and causing the water discharge to not operate and discharge the water properly. In the case of a sump pump, the pump becomes air locked and runs continuous which causes the pump to overheat, burnout and/or fail causing the area to flood and cause water damage to the building.

In many cases it is also required that after air enters the system that there is a proper seal in place to provide a radon gas, water and airtight seal after the air has been allowed to enter the system and when the pump disengages. It is also required that if failure is to occur on such an air admittance component that it must fail in a closed/sealed position providing continued protection so that no air, water or radon gas can escape into the air within the building or within a certain high of the structures roof line on the exterior.

Although some check valves have the design of a ball inside the valve to stop or open the flow to pass through the valve. However, those ball valve tends to have accumulated scum or fouls on the ball that cause the ball not able to seal the flow properly. Also, such ball valve, after having scum or fouls on the ball, will not have a proper rotation to reduce the opportunity of wearing of the ball in same location.

Another issue currently in the market is that the detection of the leakage of the valve is not easy. Since the valve has one end connected to the ambient air and one end to the plumbing system or the enclosed environment, the pressure status detected is either the ambient environment's pressure or the plumbing system's pressure. Those two pressure cannot be used to detect whether the valve is leaked or not. Often the valve is worn out and the valve seat cannot seal the foul air very well. The leakage might be subtle. Therefore, it is hard to detect from the ambient air pressure or the pressure in the plumbing system, which varied in accordance to the flow movement in the plumbing system.

Another issue also crucial to the current check valve in the market is that there is no double assurance in single valve to ensure that failure of the valve can be made up by other mechanism. Often, the current practice is to install two check valves inline, which is problematic that this practice causes too much connecting spaces and extra works, and also the losses of energy due to the energy losses in multiple connection entrances. Therefore, there is a long-felt need to resolve aforementioned issues.

### BRIEF SUMMARY OF THE INVENTION

This Brief Summary is included so as to introduce, in an abbreviated form, various topics to be elaborated upon below in the Detailed Description. This Brief Summary is not intended to identify key or essential aspects of the claimed invention. This brief Summary is similarly not intended for use as an aid in determining the scope of the claims. The subject matters of this application overcomes the aforementioned problems and may be used as an apparatus to allow or stop a flow into a piping system or an enclosed environment comprises (An apparatus to allow or stop a flow into an enclosed environment or piping system, comprising: (a) a housing having an upper flow passage, a middle flow passage, a lower flow passage, wherein the upper flow passage is above the middle flow passage, wherein the middle flow passage is above the lower flow passage, wherein an upper flow passage pressure exists in the upper flow passage, wherein a middle flow passage pressure exists in the middle flow passage, and wherein a lower flow passage pressure exists in the lower flow passage; (b) a first valve seat, wherein the first valve seat is between the upper flow passage and the middle flow passage, and wherein a first opening is formed on the first valve seat, wherein the first opening has an inner diameter; (c) a first rotary valve inside the housing, wherein the first rotary valve further comprises a main body, wherein the first rotary valve has a predetermined weight, wherein the first rotary valve can move inside the upper flow passage and above the first valve seat, wherein the first rotary valve is in an open position when the middle flow passage pressure is greater than the predetermined weight of the first rotary valve and the upper flow passage pressure, and wherein the first rotary valve is in an closed position when the middle flow passage pressure is equal to or less than the predetermined weight of the first rotary valve and the upper flow passage pressure; (d) a second valve seat, wherein the second valve seat is between the middle flow passage and the lower flow passage, wherein a second opening is formed on the second valve seat, and wherein the second opening has an inner diameter; and (e) a second rotary valve inside the housing, wherein the second rotary valve further comprises a main body, wherein the second rotary valve has a predetermined weight, wherein the second rotary valve can move inside the middle flow passage and above the second valve seat, wherein the second rotary valve is in an open position when the lower flow passage pressure is greater than the predetermined weight of the second rotary valve and the middle flow passage pressure, and wherein the second rotary valve is in an closed position when the lower flow passage pressure is equal to or less than the predetermined weight of the second rotary valve and the middle flow passage pressure. The apparatus is an invention that allows for the required volume of air to enter a piping system or an enclosed environment when there is a sufficient pressure difference between the ambient environment and the negative pressure in the piping system or an enclosed environment generating sufficient force to lift the rotary valve, the rotary valve will open and allow air/water flow to enter the piping system or enclosed environment. Therefore, the negative pressure will be eliminated.

When the piping system has radon gas, methane or other gas that generate positive pressure in the piping system or the enclosed environment the rotary valve will stay in the closed position and prevents radon gas, methane or other gas from leaving the piping system or the enclosed environment. The invention provides the proper seal by the rotary valve which has many advantage than the traditional flap valve. The rotation of the rotary valve will allow the contact points of the valve and the valve seat to constantly rotate and change, which will prolong the life of the valve. The rotation of the rotary valve will have less friction to move since rotational friction is less than static rotation. The rotation of the rotary valve will be less likely to be clogged and have less noise. The guide rail will allow the rotary valve to properly return back to the valve seat even when the air admittance and check valve is not installed vertically, which is a burdensome requirement for all other types of air admittance and check valves.

The current invention also resolves another two issues mentioned in the background: the leakage of the valve and the detection of the leakage. The dual design of the valve ensures the check valve still able to seal the flow when one of the valve seat or the valve is failed. Also, the current invention also is able to create a positive, neutral, or negative pressure within the valve. The pressure status can be known and indicated by the invention. When the pressure status changes and is detected by the invention, the leakage of the valve will be detected.

### BRIEF DESCRIPTION OF THE DRAWINGS

It should be understood that the drawings are merely representative, are not necessarily drawn to scale, and are not intended to limit the subject matter of this application.

FIG. 1 is a perspective view of one of the embodiments of the invention.

FIG. 1A is a sectional view of one of the embodiments of the invention showing that both the first rotary valve and the second rotary valve are in an open position.

FIG. 1B is a sectional view of one of the embodiments of the invention showing that first valve seat and second valve seat are flushed with soft materials.

FIG. 2 is a perspective view of one of the embodiments of the invention that shows first valve seat with first diaphragm.

FIG. 2A is a partially sectional view of one of the embodiments of the invention that first valve seat with first diaphragm.

FIG. 2B is a sectional view of one of the embodiments of the invention that shows first valve seat with first diaphragm.

FIG. 2C is another sectional view of one of the embodiments of the invention that shows first valve seat with first diaphragm.

FIG. 3 is a perspective view of one of the embodiments of the invention that shows second valve seat with second diaphragm.

FIG. 3A is a partially sectional view of one of the embodiments of the invention that shows second valve seat with second diaphragm.

FIG. 3B is a sectional view of one of the embodiments of the invention that shows second valve seat with second diaphragm.

FIG. 3C is a sectional view of one of the embodiments of the invention that shows second valve seat with second diaphragm.

FIG. 4 is a perspective view of one of the embodiments of the invention that shows first valve seat with first diaphragm and second valve seat with second diaphragm.

FIG. 4A is a partially sectional view of one of the embodiments of the invention that shows first valve seat with first diaphragm and second valve seat with second diaphragm.

FIG. 4B is a partially sectional view of one of the embodiments of the invention that shows first valve seat with first diaphragm and second valve seat with second diaphragm.

FIG. 5 is a schematic view of one of the embodiments of the rotary valve of the invention.

FIG. 6 is a schematic view of one of the embodiments of the rotary valve with turbulator on the guides.

FIG. 7 is a schematic view of one of the embodiments of the rotary valve with turbulator on the main body of the rotary valve.

FIG. 8 is a schematic view of one of the embodiments of the rotary valve in disk shape.

FIG. 9 is a prospective view of one of embodiments that has guides and guide rails.

FIG. 9A is a sectional view of one of embodiments that has guides and guide rails.

FIG. 10 is a prospective view of one of embodiments that has guides and guide rails that are slated to an angle.

FIG. 10A is a sectional view of one of embodiments that has guides and guide rails that are slated to an angle.

FIG. 11 is a partially perspective view of one of embodiments that has cages.

FIG. 12 is a schematic view of one of the embodiments of the invention inside an enclosed environment.

FIG. 13 is a schematic view of one of the embodiments of the invention outside an enclosed environment.

FIG. 14 is a schematic view of one of the embodiments of the invention installed in a piping system.

FIG. 15 is a schematic view of one of the embodiments of the invention installed in another piping system.

FIG. 16 is a perspective view of one of the embodiments that invention with pressure indicator.

FIG. 17 is a perspective view of one of the embodiments that pressure indicator indicating a low pressure status.

FIG. 18 is a perspective view of one of the embodiments that pressure indicator indicating a high pressure status.

### DETAILED DESCRIPTION

Before the present invention is described in greater detail, it is to be understood that this invention is not limited to particular embodiments described, and as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Other than in the embodiment or example, or where indicated otherwise, all numbers indicating ingredient quantities and/or reaction conditions are to be understood as being modified in every instance by the word “about,” which means the ingredient quantities or reaction conditions are within 10 percent to 15 percent of the indicated value.

Unless defined otherwise, all terms used herein have the same meaning as commonly understood by one of ordinary skill in the art to which this invention belongs. Although any methods and materials similar or equivalent to those described herein can be used in the practice or testing of the present invention, some potential and exemplary methods and materials may now be described. Any and all publications mentioned herein are incorporated herein by reference to disclose and describe the methods and/or materials in connection with which the publications are cited. It is understood that the present disclosure supersedes any disclosure of an incorporated publication to the extent there is a contradiction.

It must be noted that as used herein and in the appended claims, the singular forms “a”, “an”, and “the” may also include the plural referents unless the context clearly dictates otherwise.

It is further noted that the claims may be drafted to exclude any element that may be optional. As such, this statement is intended to serve as antecedent basis for use of such exclusive terminology as “solely”, “only” and the like in connection with the recitation of claim elements, or the use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention.

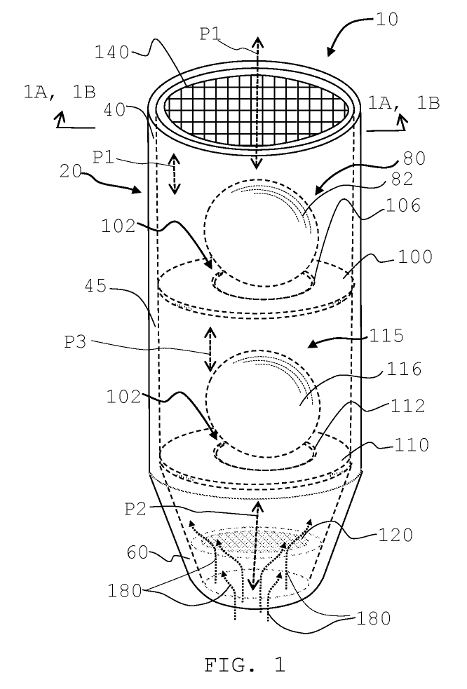

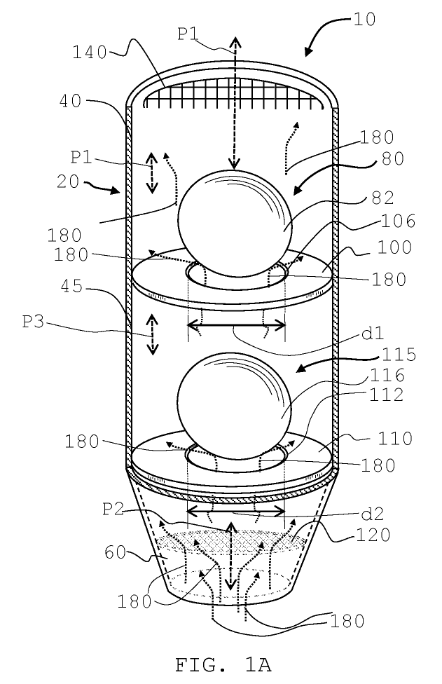

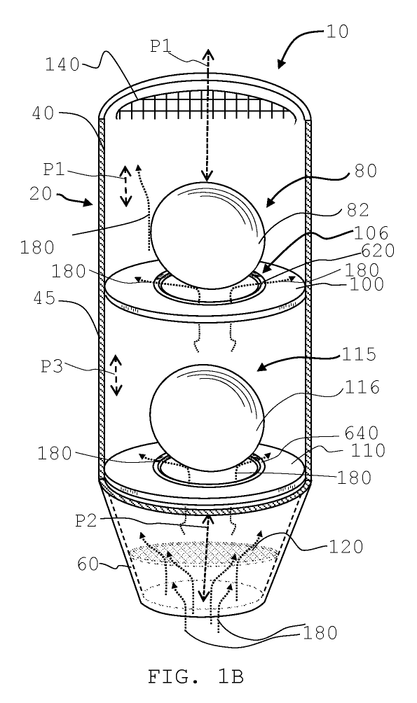

Referring to FIG. 1 and FIG. 1A, one of the preferred embodiment of an apparatus 10 comprises (a) a housing 20 having an upper flow passage 40, a middle flow passage 45, a lower flow passage 60, wherein the upper flow passage 40 is above the middle flow passage 45, and wherein the middle flow passage 45 is above the lower flow passage 60; (b) a first valve seat 100, wherein the first valve seat 100 is between the upper flow passage 40 and the middle flow passage 45, wherein one first opening 106 is formed on the first valve seat 100; (c) a first rotary valve 80 inside the housing 20, wherein the first rotary valve 80 further comprises a main body 82, wherein the first rotary valve 80 has a predetermined weight, and wherein the first rotary valve 80 can move inside the upper flow passage 40 and above the first valve seat 100, wherein the first rotary valve 80 is in an open position 102 when the middle flow passage pressure P3 is greater than the predetermined weight of the first rotary valve 80 and the upper flow passage pressure P1; (d) a second valve seat 110, wherein the second valve seat 110 is between the middle flow passage 45 and the lower flow passage 60, wherein one second opening 112 is formed on the second valve seat 110, and wherein a second opening 112 is formed on the second valve seat 110; and (e) a second rotary valve 115 inside the housing 20, wherein the second rotary valve 115 further comprises a main body 116, wherein the second rotary valve 115 has a predetermined weight, and wherein the second rotary valve 115 can move inside the middle flow passage 45 and above the second valve seat 110, wherein the second rotary valve 115 is in an open position 102 when the lower flow passage pressure P2 is greater than the predetermined weight of the second rotary valve 115 and the middle flow passage pressure P3. The first rotary valve 80 and second rotary valve 115 can be hollow and be filled with Argon gas so that the size of rotary valve will be inert to the ambient temperature changes. The less change of the rotary valve will be better off to seal off the valve consistently.

Also referring to FIG. 1, in one embodiment, the lower flow passage filter 120 in the lower flow passage 60 and the upper flow passage filter 140 in the upper flow passage 40 prevents particles and pollutants in the flow 180 from entering the housing 20 and prevents foreign objects, such as particles and bugs, from passing through the apparatus 10, which will be detrimental to the seal 160 between the first rotary valve 80 and the first valve seat 100. The apparatus 10 can be connected with other pipes or conduits by any types of pipe connection, such as but not limited to fastener, treaded pipe, solvent welding, soldering, brazing, welding compression fittings, or crimped. The material of the housing 20 can be such as but not limited to plastic, copper, brass, cast iron, steel, and other commonly used in the field of art of piping.

Referring to FIG. 1B, in one embodiment of the apparatus of claim 1, wherein an inner circumference of the first opening 106 of the first valve seat 100 is flushed with soft material 620, and wherein the main body 82 of the first rotary valve 80 is dimensioned and configured to be between the size of the first opening 106 of the first valve seat 100 and the size of the upper flow passage 40. Note that the second opening 112 of the second valve seat 110 can be flushed with soft material 640. Or, both the first opening 106 or second opening 112 can be flushed with soft materials. The soft materials can be material having a Shore Hardness between about 20A and about 50A, such as but not limited to rubber, EPDM (Ethylene Propylene Diene Monomer), silicon, and combination thereof. The soft material flushed on the first opening 106, or second opening 112, or both is to enhance the contact between the first rotary valve 80 with the first opening 106 and the contact between the second rotary valve 115 with the second opening 112 so that first opening 106 and second opening 112 can be substantially sealed.

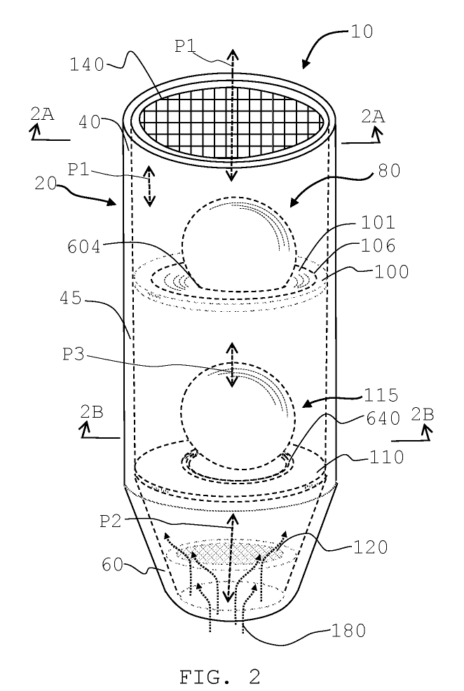

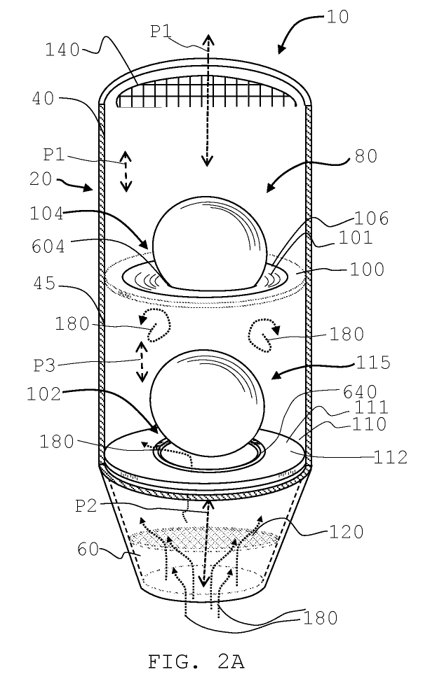

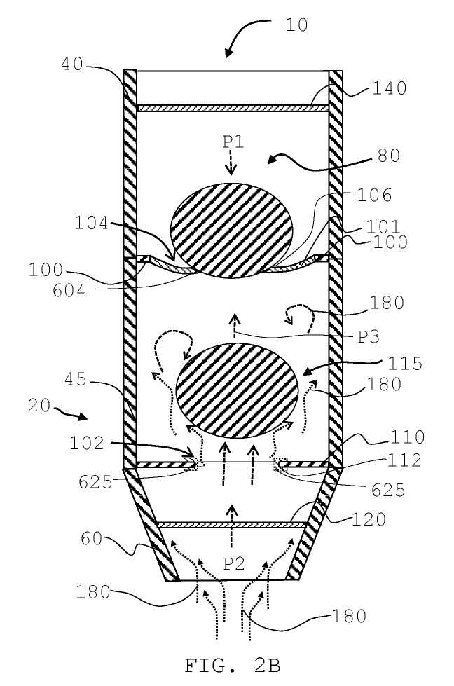

Referring to FIG. 2, FIG. 2A, FIG. 2B, and FIG. 2C, in one preferred embodiment of the apparatus 10, wherein the first valve seat 100 further comprises a first diaphragm 101 made of flexible, resilient material, wherein the first diaphragm 101 is in a ring-shape, wherein a first center opening 604 is formed on the first diaphragm 101, wherein the first diaphragm 101 covers the first opening 106, wherein the first center opening 604 is coaxial with the first opening 106 of the first valve seat 100, wherein the main body 82 of the first rotary valve 80 is dimensioned and configured to be between the first center opening 604 and the upper flow passage 40, wherein the first diaphragm 101 can be deformed downwardly when the first rotary valve 80 is disposed on the first diaphragm 101. In same preferred embodiment, wherein the second valve seat 110 is made of hard material, wherein an inner circumference of the second opening 112 of the second valve seat is flushed with soft material 640, and wherein the main body 116 of the second rotary valve 115 is dimensioned and configured to be between the second opening 112 of the second valve seat 110 and the middle flow passage 45. Under this configuration of the preferred embodiment of the apparatus 10 as shown in FIG. 2, FIG. 2A, FIG. 2B and FIG. 2C, the first rotary valve 80 is in a closed position 104 when the middle flow passage pressure P3 is equal to or less than the predetermined weight of the first rotary valve 80 and the upper flow passage pressure Pl. When the first rotary valve 80 is in a closed position 104, the first rotary valve 80 is disposed on the first diaphragm 101 and seals the first center opening 604. When the lower flow passage P2 is greater than the weight of the second rotary valve 115 and the middle flow passage pressure P3, the second rotary valve 115 is in an open position 102 and the second rotary valve 115 is lifted away from the second valve seat 110, which will allow a flow 180 to flow from lower flow passage 60 to middle flow passage 45 through the second opening 112. In same one embodiment of the apparatus 10 shown in FIG. 2C, the lower flow passage P2 is less than the weight of the second rotary valve 115 and the middle flow passage pressure P3, the second rotary valve 115 is in a closed position 104 and the second rotary valve 115 is disposed one the second valve seat 110, which will stop a flow 180 from passing through the second opening 112. Now the middle flow passage pressure P3 will become relatively increased because the first diaphragm 101 of the first valve seat 100 moves downwardly to create a compression effect in the middle flow passage 45, which results in an increase of the middle flow passage pressure P3. When the relatively increased pressure of the middle flow passage pressure P3 is detected, it means that there is no leakage of flow 180 between the first rotary valve 80 and first diaphragm 101 as well as between second rotary valve 115 and the second valve seat 110.

Also referring to FIG. 2, FIG. 2A, FIG. 2B, and FIG. 2C, in one embodiment of the invention, in one preferred embodiment of the invention, a lower flow passage pressure P2 in the lower flow passage 60 is about 8.7 pounds per square inch (60 Kilopascal) greater than the upper flow passage pressure P1 above the first valve seat 100, wherein the flow 180 will flow through the housing 20 and the upper flow passage 40 when the first rotary valve 80 is lifted. The weight of The first rotary valve 80 can be depended on the pressure difference that the apparatus 10 is designed to control of stopping or allowing the air or water passage. In one preferred embodiment of the invention, the first rotary valve 80 may have a predetermined weight from about 0.01 ounce to about one pound and one ounce, depending on the application of the invention in different enclosed environment or piping systems that have difference pressures inside the enclosed environment or piping system.

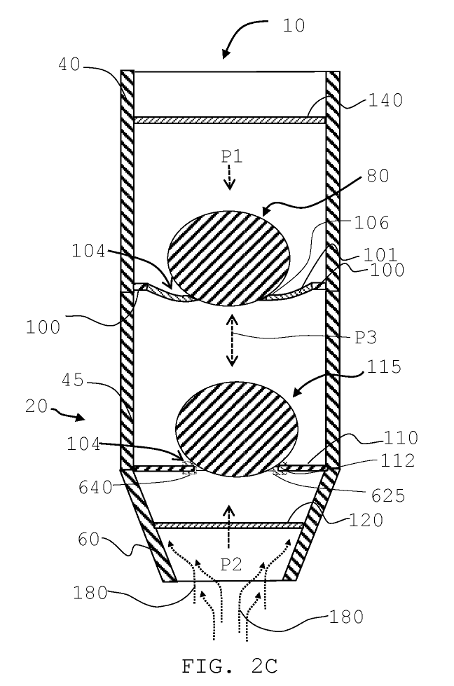

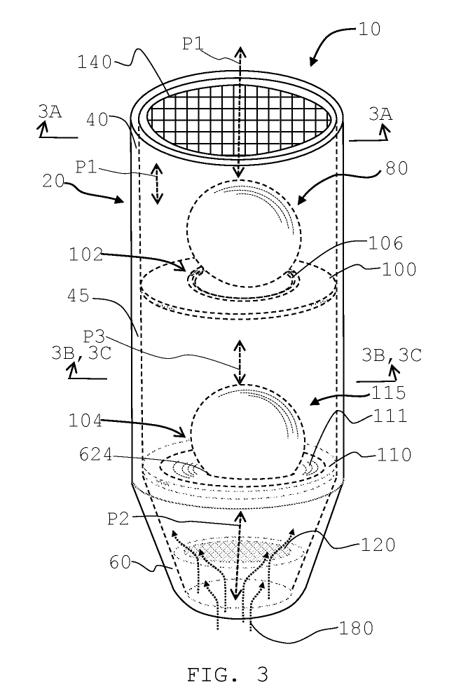

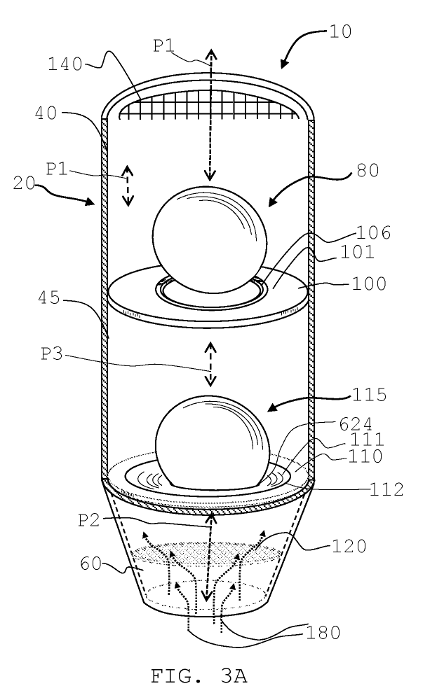

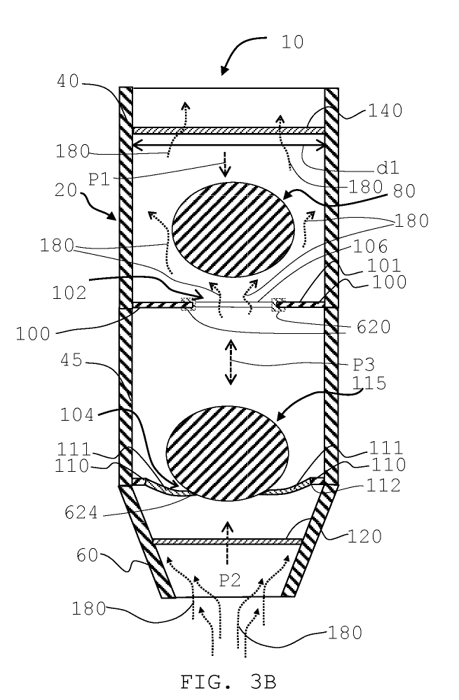

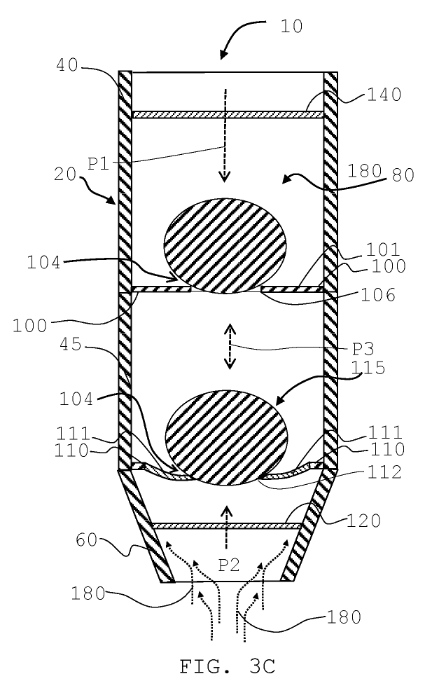

Referring to FIG. 3, FIG. 3B, and FIG. 3C, in one embodiment of the apparatus 10, wherein the second valve seat 110 further comprises a second diaphragm 111 made of flexible, resilient material, wherein the second diaphragm 111 is in a ring-shape, wherein a second center opening 624 is formed on the second diaphragm 111, wherein the second diaphragm 111 covers the second center opening 624, wherein the second center opening 624 is coaxial with the second opening 112 of the second valve seat 110, wherein the main body 116 of the second rotary valve 115 is dimensioned and configured to be between the second center opening 624 and the middle flow passage 45, and wherein the second diaphragm 111 can be deformed downwardly when the second rotary valve 115 is disposed on second diaphragm 111. Under the same one embodiment of the apparatus 10, the first valve seat 100 is made of hard material, wherein an inner circumference of the first opening 106 of the first valve seat 100 is flushed with soft material 620, wherein the main body 82 of the first rotary valve 80 is dimensioned and configured to be between the first opening 106 of the first valve seat 100 and the upper flow passage 40. When the lower flow passage pressure P2 is less than the middle flow passage pressure P3 and the weight of the second rotary valve 115, the second rotary valve 115 is in a closed position 104 and the second rotary valve 115 is disposed on the second diaphragm 111, which blocks the flow 180 from passing the second center opening 624. When both the first rotary valve 80 and the second rotary valve 115 are in a closed position 104, the middle flow passage pressure P3 will become relatively decreased because the second diaphragm 111 of the second valve seat 110 moves downwardly to create an expansion effect in the middle flow passage 45, which results in a decrease of the middle flow passage pressure P3.

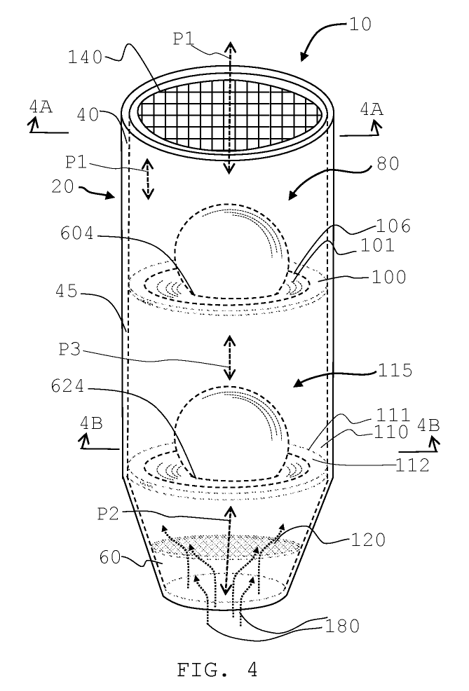

Referring to FIG. 4, FIG. 4A, and FIG. 4B, in one embodiment of the apparatus 10, wherein the first valve seat 100 further comprises a first diaphragm 101 made of flexible, resilient material, wherein the first diaphragm 101 is in a ring-shape, wherein a first center opening 604 is formed on the first diaphragm 101, wherein the first diaphragm 101 covers the first opening 106, wherein the first center opening 604 is coaxial with the first opening 106 of the first valve seat 100, wherein the main body 82 of the first rotary valve 80 is dimensioned and configured to be between the first center opening 604 and the upper flow passage 40, wherein the first diaphragm 101 can be deformed downwardly when the first rotary valve 80 is disposed on the first diaphragm 101. In same embodiment of the apparatus 10, wherein the second valve seat 110 further comprises a second diaphragm 111 made of flexible, resilient material, wherein the second diaphragm 111 is in a ring-shape, wherein a second center opening 624 is formed on the second diaphragm 111, wherein the second diaphragm 111 covers the second center opening 624, wherein the second center opening 624 is coaxial with the second opening 112 of the second valve seat 110, wherein the main body 116 of the second rotary valve 115 is dimensioned and configured to be between the second center opening 624 and the middle flow passage 45, and wherein the second diaphragm 111 can be deformed downwardly when the second rotary valve 115 is disposed on second diaphragm 111. When both the first rotary valve 80 and the second rotary valve 115 are in a closed position 104, the middle flow passage pressure P3 may be varied depending on the relative degree of deformation by the first diaphragm 101 and the second diaphragm 111. When the deformation of the first diaphragm 101 is greater than the deformation of the second diaphragm 111, there is a compression effect in the middle flow passage 45, which will result in an increase of the middle flow passage pressure P3. When the deformation of the second diaphragm 111 is greater than the deformation of the first diaphragm 101, there is an expansion effect in the middle flow passage 45, which will result in a decrease of the middle flow passage pressure P3. If first diaphragm 101 and second diaphragm 111 deforms by same degree, the middle flow passage pressure P3 will not be relatively increased or decreased. The degree of deformation of the first diaphragm 101 and the second diaphragm 111 can be varied by the predetermined weight of the first rotary valve 80 and the second rotary valve 115, by which heavier weight will cause more deformations. Also, the deformation of the first diaphragm 101 and the second diaphragm 111 can be achieved by using soft materials with different Shore Hardness. The soft material is having Shore Hardness between about 20 A and about 50 A. Lower Shore Hardness means softer material, which will be deformed more. Therefore, with same weight of first rotary valve 80 and second rotary valve 115, if first diaphragm 101 is made of soft material with lower Shore Hardness, for example, 20 A, and the second diaphragm 111 uses soft material with Shore Hardness 30 A, then the first diaphragm 101 will deform more than the second diaphragm 111.

Note that, a hard material may have a Shore Hardness between 60 A and about 90 A, such as but not limited to rubber, EPDM (Ethylene Propylene Diene Monomer), silicon, and combination thereof. Hard materials can also be, but not limited to, PVC (Polyvinyl chloride), metal, or HDPE (High Density Polyethylene). A soft material or flexible, resilient material may have a Shore Hardness between about 20 A and about 50 A, such as but not limited to rubber, synthetic rubber, EPDM (Ethylene Propylene Diene Monomer), silicon, and combination thereof.

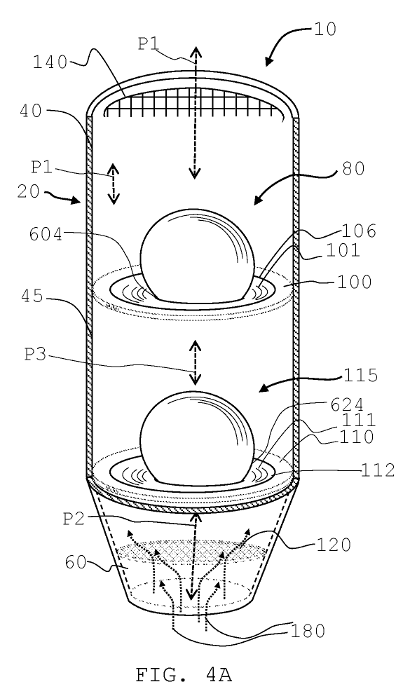

Referring to FIG. 5, in one embodiment of the apparatus 10, The first rotary valve 80 has a main body 82 in an oval shape with two first guides 84 mounted to the main body 82 opposite to each other (first guides 84). The first rotary valve 80 as well as the second rotary valve 115 (not shown) can be rotated by flow 180.

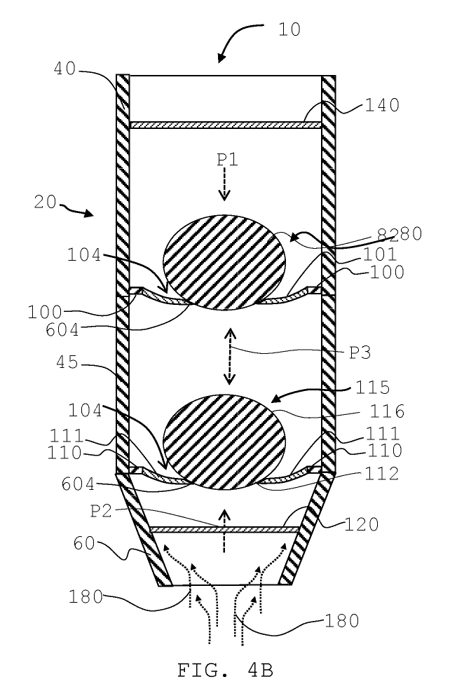

Referring to FIG. 6, in one embodiment of the apparatus 10 further comprises two turbulators 400 mounted on each of the two first guides 84, wherein the two turbulators 400 comprises a plurality of impellers 420 radially mounted to each of the first guides 84, and wherein the two turbulators 400 rotate the first rotary valve 80 when the flow 180 from the lower flow passage 60 pushes the plurality of impellers 420. The plurality of impellers 420 slated in one single direction will ensure the first rotary valve 80 rotate in one direction and faster than The first rotary valve 80 without the two turbulators 400. The uniform rotation direction of The first rotary valve 80 will increase the speed of the first rotary valve 80 going up to open the first rotary valve 80. The increased rotation speed of the first rotary valve 80 will allows the self-cleaning of the valve to remove foul or scum accumulated on the first rotary valve 80 and the first opening 106. The same working principle of two turbulator 400 applies to the second rotary valve 115 and second guides 118.

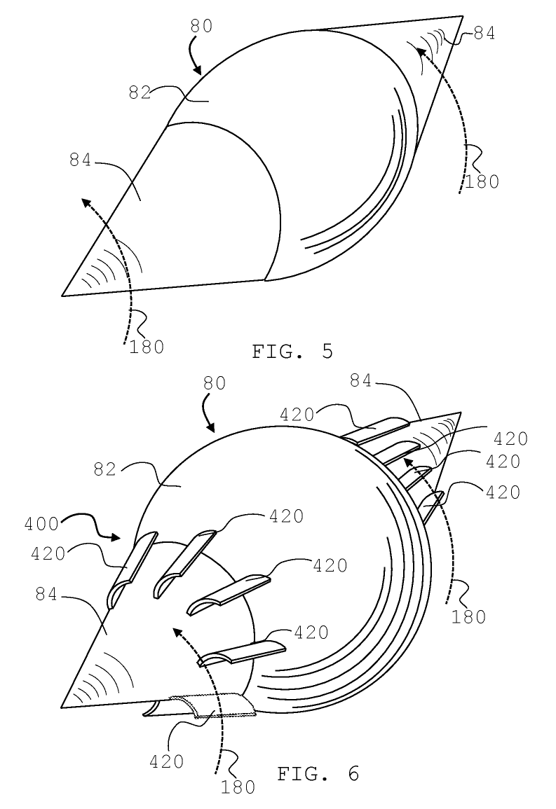

Referring to FIG. 7, in one embodiment of the apparatus 10 further comprises two turbulators 400, wherein each of the two turbulators 400 comprises a plurality of impellers 420 mounted to the main body 82 of the first rotary valve 80, wherein the plurality of impellers 420 are arranged in a circle around each of two first guides 84, wherein each of the two turbulators 400 are opposite to each other, and wherein the two turbulators 400 rotate the first rotary valve 80 when the flow 180 from the lower flow passage 60 pushes the plurality of impellers 420. The plurality of impellers 420 in one single direction will ensure The first rotary valve 80 rotate in one direction and faster than The first rotary valve 80 without turbulators 400. The uniform rotation direction of The first rotary valve 80 will increase the speed of the first rotary valve 80 going up to open The first rotary valve 80. The same working principle of two turbulator 400 applies to the second rotary valve 115 and second guides 118.

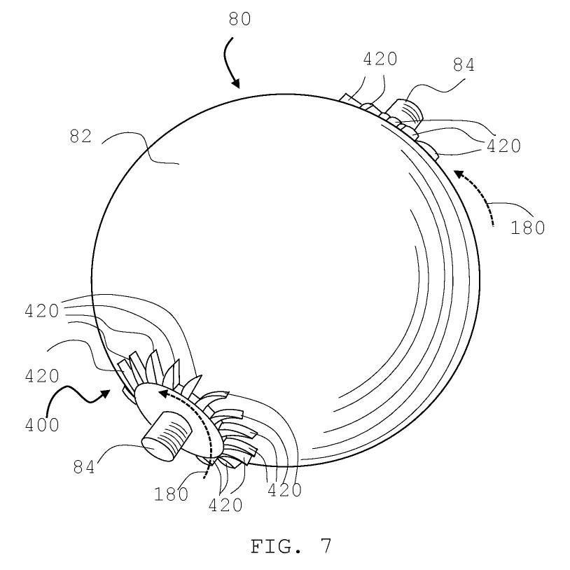

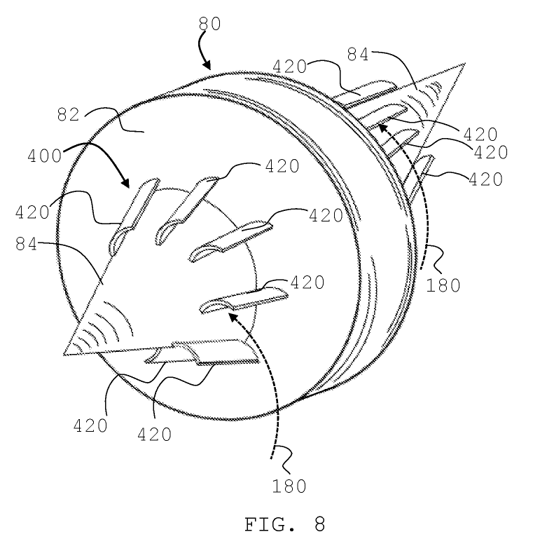

Referring to FIG. 8, in one embodiment of the apparatus 10, the main body 82 has a disc shape with turbulators 400 comprising a plurality of impellers 420. The main body 82 of the first rotary valve 80 can be in different rotatable shapes, such as oval, disc, round, or cylinder. Same configuration of a disk shape applies to the main body 116 of second rotary valve 115.

Referring to FIG. 9 and FIG. 9A, in one embodiment of the invention, the apparatus 10 further comprises (a) two first guides 84 mounted to the main body 82 of the first rotary valve 80, wherein the two first guides 84 are opposite to each other; (b) two first guide rails 50 disposed inside upper flow passage 40 for guiding the first rotary valve 80 between an open position 102 and a closed position 104, wherein the each of two first guides 84 of the first rotary valve 80 are disposed in each of the two first guide rails 50, wherein the two first guides 84 move freely in the two first guide rails 50, wherein the two first guide rails 50 are attached to the housing 20; (c) two second guides 118 mounted to the main body 116 of the second rotary valve 115, wherein the two second guides 118 are opposite to each other; and (d) two second guide rails 52 disposed inside middle flow passage 45 for guiding the second rotary valve 115 between an open position 102 and a closed position 104, wherein the each of two second guides 118 of the second rotary valve 115 are disposed in each of the two second guide rails 52, wherein the two second guides 118 move freely in the two second guide rails 52, and wherein the two second guide rails 52 are attached to the housing 20. The two first guide rails 50 are attached, by assembly or molding, to the first valve seat 100 and the two second guide rails 52 are attached by assembly or molding, to the second valve seat 110.

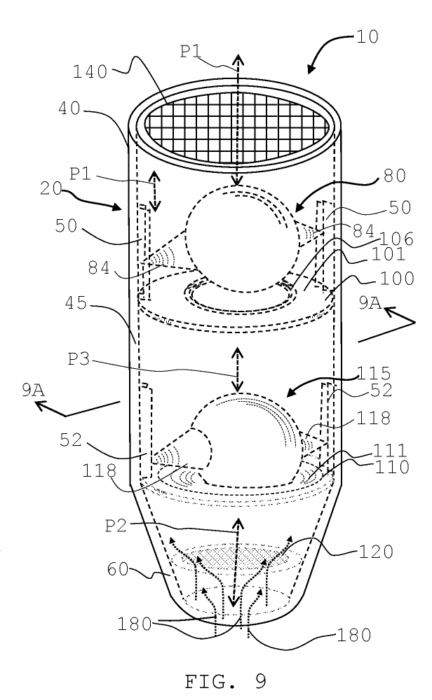

Referring to FIG. 10 and FIG. 10A in one of the embodiments of the invention, the first guide rails 50 and second guide rails 52 are slated to an angle A between about 45 degrees and about 89 degrees with the first valve seat 100 and second valve seats 110, respectively. Along the first guide rails 50 and second guide rail 52, the first rotary valve 80 and the second rotary valve 115 can rolls up and move sideways. Therefore, a portion of the upper flow passage 40 and middle flow passage will be protruded out to accommodate the sideways of The first rotary valve 80 and second rotary valve 115.

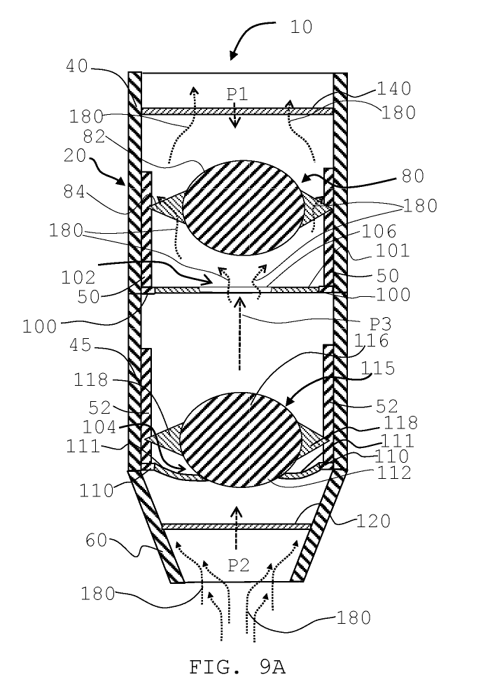

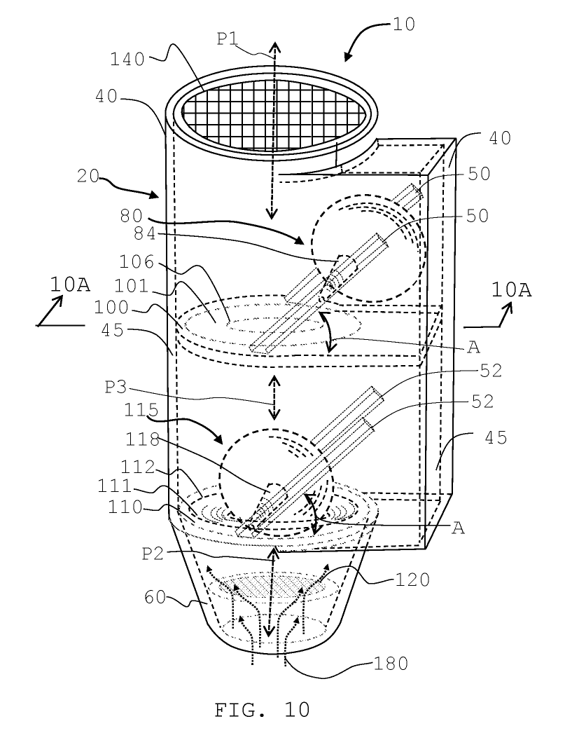

Referring to FIG. 11, in one embodiment, the apparatus 10 further comprises a first cage 700 and a second cage 720, wherein a plurality of openings 710 are formed on each of the first cage 700 and the second cage 720, wherein the first cage 700 is attached to the first valve seat 100, wherein the first rotary valve 80 is disposed in said first cage 700, wherein the first rotary valve 80 can move inside the first cage 700 and above the first valve seat 100, wherein the second cage 720 is attached to the second valve seat 110, wherein the second rotary valve 115 is disposed in the second cage 720, wherein the second rotary valve 115 can move inside the second cage 720 and above the second valve seat 110. The attachment of the first cage 700 to the first valve seat 100 can be by assembly or by modeling in one piece. The attachment of the second cage 720 to the second valve seat 110 can be by assembly or by modeling in one piece.

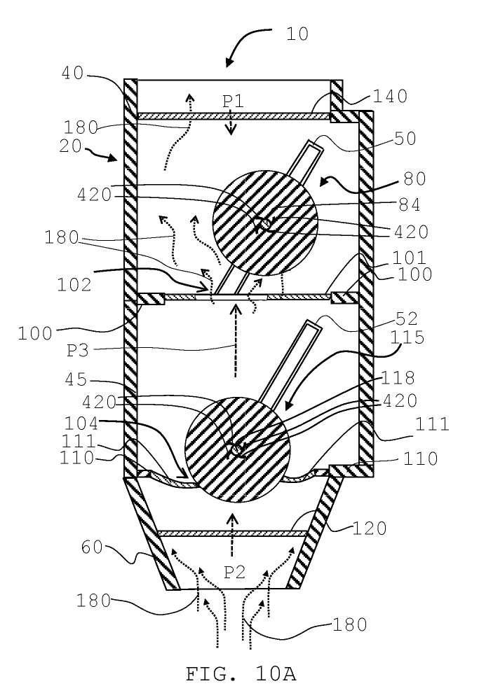

Referring to FIG. 12 and FIG. 1, in one embodiment of the apparatus 10, the apparatus 10 is inside an enclosed environment 200, wherein the enclosed environment 200 has an ambient pressure same as the upper flow passage pressure P1 in the enclosed environment 200, wherein the enclosed environment 200 further comprises at least one conduit 210, wherein each the at least one conduit 210 has a first end 212 and a second end 214, wherein each of the at least one conduit 210 has the first end 212 connected to the lower flow passage 60 of the apparatus 10 and the second end 214 extends out of the enclosed environment 200, wherein the upper flow passage 40 is opened and adapted to the ambient pressure P1 of the enclosed environment 200, wherein the enclosed environment 200 has at least one pumping device 220, which conveys water and/or air 222 in the enclosed environment 200 to outside the enclosed environment 200, and wherein the at least one pumping device 220 causes a pressure difference to the apparatus 10 when the at least one pumping device 220 conveys water and/or air 222 through at least one pipe 224 out of the enclosed environment 200. The pumping of pumping device 220 will cause a vacuum, relatively negative pressure situation, which causes the upper flow passage pressure P1 in the enclosed environment 200 to drop, and the middle flow passage flow pressure P3 becomes greater than the upper flow passage pressure P1 and the weight of the first rotary valve 80. As a result, the first rotary valve 80 will be lifted away from the first valve seat 100. If the lower flow passage pressure P2 in the lower flow passage 60 becomes greater than middle flow passage pressure P3 and the weight of The second rotary valve 115, a lifting force to lift the second rotary valve 115 off the second valve seat 110 to allow flow 180 from lower flow passage 60 to upper flow passage 40 and the enclosed environment 200 to release the relatively negative pressure condition. In one preferred flow 180 of 12 cubic inch/Second per each millimeter of pipe 224 of the at least one pumping device 220. In the enclosed environment where a pump is in operation, in one embodiment, a middle flow passage pressure P3 in the middle flow passage 45 is about 8.7 pounds per square inch (60 Kilopascal) greater than the upper flow passage pressure P1, the weight of the first rotary valve 80. the lower flow passage pressure P2 in the lower flow passage 60 is about 8.7 pounds per square inch (60 Kilopascal) greater than the middle flow passage pressure P3, the weight of the second rotary valve 115. The apparatus 10 is designed to provide flow 180, if air, of 12 cubic inch/Second per each millimeter of pipe 224 of the enclosed environment in which at least one pumping device 220 is located, but the design flow may be varied with different scale of enclosed environment.

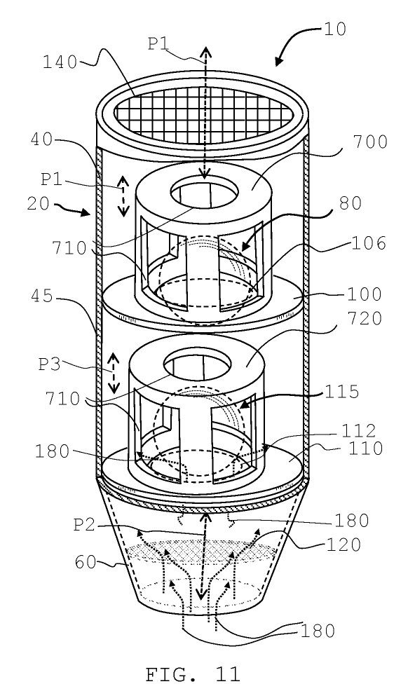

Referring to FIG. 13 in one embodiment of the apparatus 10, the apparatus 10 is outside an enclosed environment 200, wherein the enclosed environment 200 has an ambient pressure in the enclosed environment 200 same as the upper flow passage pressure p1, wherein the enclosed environment 200 further comprises at least one conduit 210, wherein each the at least one conduit 210 has a first end 212 and a second end 214, wherein each of the at least one conduit 210 has the first end 212 connected to the upper flow passage 40 of the apparatus 10 and the second end 214 extends into the enclosed environment 200, wherein the upper flow passage 40 is opened and adapted to the ambient pressure P1 of the enclosed environment 200, wherein the enclosed environment 200 has at least one pumping device 220, which conveys water and/or air 222 in the enclosed environment 200 to outside the enclosed environment 200. The pumping of pumping device 220 will cause a vacuum, relatively negative pressure situation, which causes the upper flow passage pressure P1 in the enclosed environment 200 to drop, and the middle flow passage flow pressure P3 becomes greater than the upper flow passage pressure P1 and the weight of the first rotary valve 80. As a result, the first rotary valve 80 will be lifted away from the first valve seat 100. If the lower flow passage pressure P2 in the lower flow passage 60 becomes greater than middle flow passage pressure P3 and the weight of The second rotary valve 115, a lifting force to lift the second rotary valve 115 off the second valve seat 110 to allow flow 180 from lower flow passage 60 to upper flow passage 40 and the enclosed environment 200 to release the relatively negative pressure condition. In one preferred embodiment, the apparatus 10 is designed to flow 180 of 12 Cubic Inch/Second per each Millimeter of pipe 224 of the at least one pumping device 220.

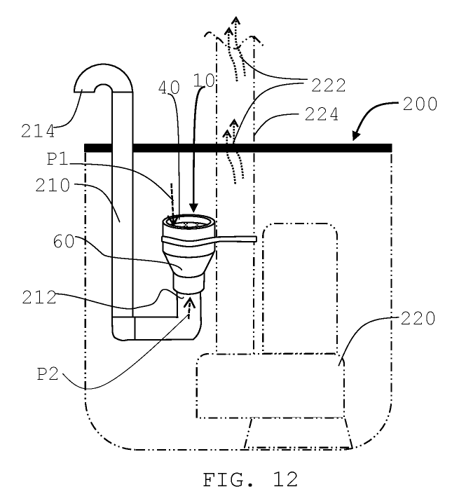

Referring to FIG. 14 and FIG. 1, in one embodiment of the apparatus 10, the apparatus 10 is installed to an piping system 300, wherein piping system 300 wherein the piping system 300 further comprises at least one conduit 210, wherein each the at least one conduit 210 connected to the upper flow passage 40 of the apparatus 10, wherein the upper flow passage 40 has an upper flow passage P1 adapted to the ambient pressure of the piping system 300, wherein a draining flow 190 is drained from the piping system 300 causing a relatively negative pressure situation, which causes the upper flow passage pressure P1 in the enclosed environment 200 to drop, and the middle flow passage flow pressure P3 becomes greater than the upper flow passage pressure P1 and the weight of the first rotary valve 80. As a result, the first rotary valve 80 will be lifted away from the first valve seat 100. If the lower flow passage pressure P2 in the lower flow passage 60 becomes greater than middle flow passage pressure P3 and the weight of The second rotary valve 115, a lifting force to lift the second rotary valve 115 off the second valve seat 110 to allow flow 180 from lower flow passage 60 to upper flow passage 40 and the piping system 300 to release the relatively negative pressure condition. In the embodiment of apparatus 10 installed in a piping system for air admittance, the pressure difference between the middle flow passage pressure P3 and the upper flow passage pressure P1 or the pressure difference between the middle flow passage pressure P3 and the lower flow passage pressure P2 is generally about 0.05 inches of water column to 2 inches of water column (12.442 Pascal to 497.68 Pascal), but the pressure difference may vary with the scale of the piping system. The air admittance requirement for the flow 180 into the piping system 300 is generally 1 cubic feet per minute or 0.47 litter per second, but it may vary with the scale of the piping system 300.

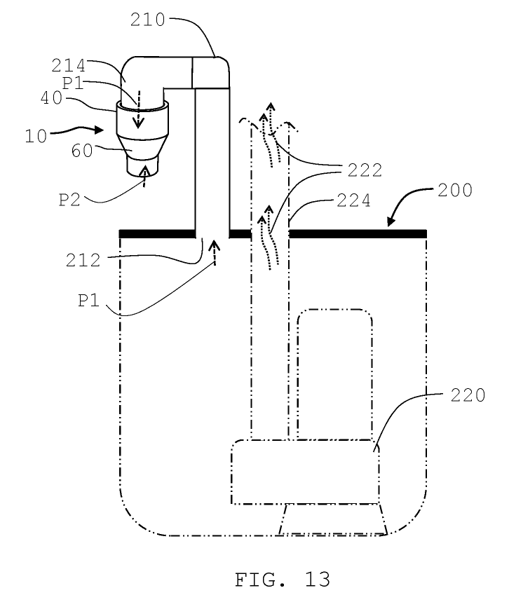

Referring to FIG. 15 and FIG. 1 in one embodiment of the apparatus 10, the apparatus 10 is installed in a piping system 300, wherein the piping system has a flow 180 moves between a lower elevation position 310 of the piping system 300 to a upper elevation position 320 of the piping system 300, wherein the upper flow passage 40 of the apparatus 10 is communicated with the upper flow passage 40 communicated with the upper elevation position 320 of the piping system 300, wherein the lower flow passage 60 is communicated with the lower elevation position 310 of the piping system 300, wherein the first rotary valve 80 and the second rotary valve 115 is in an open position 102, wherein the flow 180 moves from the lower elevation position 310 of the piping system 300 toward the upper elevation position 320 of the piping system 300, and wherein the first rotary valve 80 and the second rotary valve 115 is in a closed position 104 wherein the flow 180 moves from the upper elevation position 320 of the piping system 300 toward the lower elevation position 310 of the piping system 300.

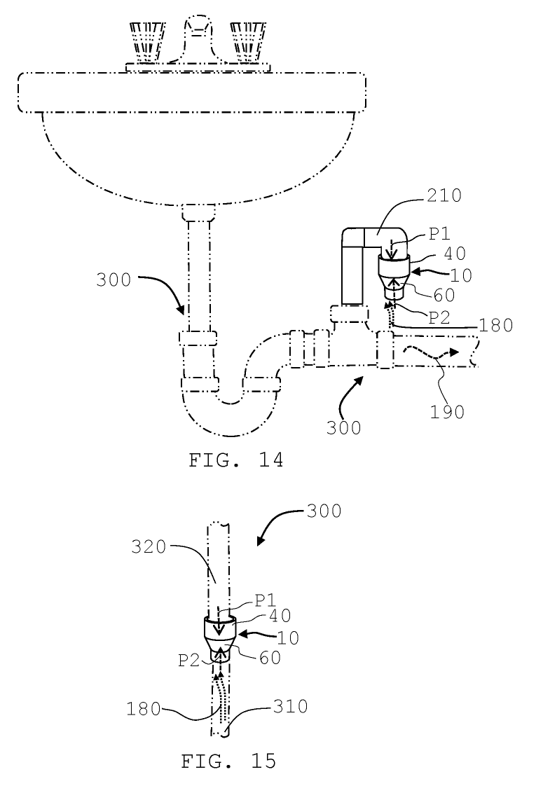

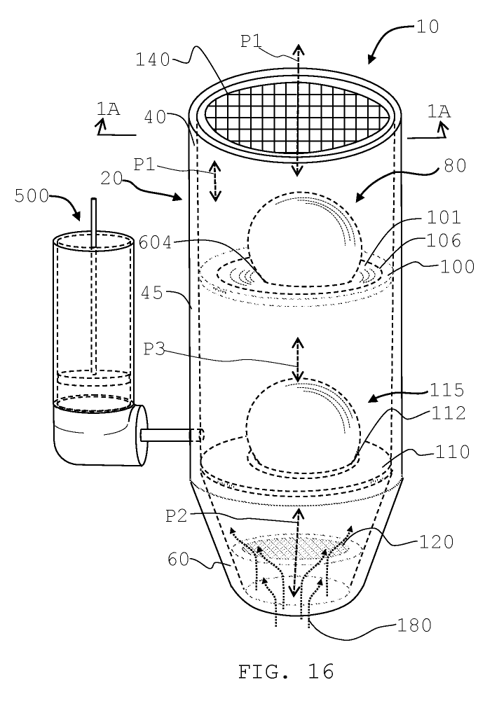

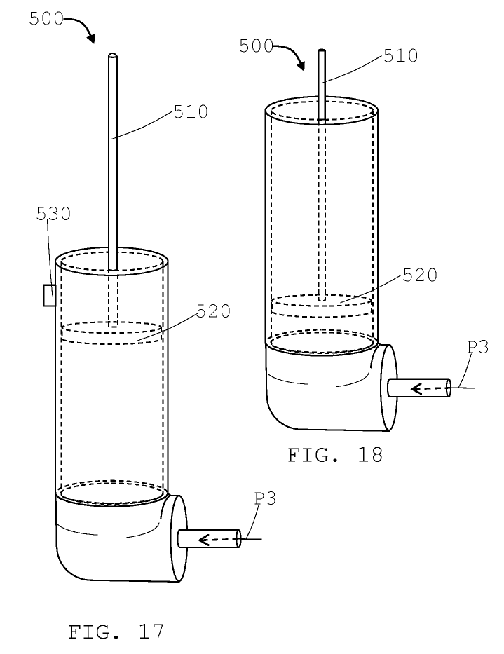

Referring to FIG. 16, FIG. 17, and FIG. 18, in one embodiment of the invention, the apparatus 10, further comprise a pressure indicator 500 responsive to the middle flow passage pressure P3, wherein the pressure indicator 500 is visible on an external surface of the housing 20, and wherein the pressure indicator 500 shows a pressure status of the middle flow passage pressure P3. When the middle flow passage pressure P3 is high (FIG. 16), the middle flow passage pressure P3 will push a piston 520 of the pressure indicator 500 up, which will elevate an indicator rod 510 to indicator a high pressure status. When the middle flow passage pressure P3 is low (FIG. 17), the middle flow passage pressure P3 will retract a piston 520 of the pressure indicator 500 down, which will lower an indicator rod 510 to indicator a low pressure status. The apparatus 10 can further comprises a signal transmitter 530 to transmit the pressure status of the pressure indicator 500. Also noted is that the pressure indicator 500 can be other types of pressure gauges.

What claimed is:

1. An apparatus to allow or stop a flow into an enclosed environment or piping system, comprising:
(a) a housing having an upper flow passage, a middle flow passage, a lower flow passage, wherein said upper flow passage is above said middle flow passage, wherein said middle flow passage is above said lower flow passage, wherein an upper flow passage pressure exists in said upper flow passage, wherein a middle flow passage pressure exists in said middle flow passage, and wherein a lower flow passage pressure exists in said lower flow passage;
(b) a first valve seat, wherein said first valve seat is between said upper flow passage and said middle flow passage, and wherein a first opening is formed on said first valve seat, wherein said first opening has an inner diameter;
(c) a first rotary valve inside said housing, wherein said first rotary valve further comprises a main body, wherein said first rotary valve has a predetermined weight, wherein said first rotary valve can move inside said upper flow passage and above said first valve seat, wherein said first rotary valve is in an open position when said middle flow passage pressure is greater than said predetermined weight of said first rotary valve and said upper flow passage pressure, and wherein said first rotary valve is in an closed position when said middle flow passage pressure is equal to or less than said predetermined weight of said first rotary valve and said upper flow passage pressure;
(d) a second valve seat, wherein said second valve seat is between said middle flow passage and said lower flow passage, wherein a second opening is formed on said second valve seat, and wherein said second opening has an inner diameter; and
(e) a second rotary valve inside said housing, wherein said second rotary valve further comprises a main body, wherein said second rotary valve has a predetermined weight, wherein said second rotary valve can move inside said middle flow passage and above said second valve seat, wherein said second rotary valve is in an open position when said lower flow passage pressure is greater than said predetermined weight of said second rotary valve and said middle flow passage pressure, and wherein said second rotary valve is in an closed position when said lower flow passage pressure is equal to or less than said predetermined weight of said second rotary valve and said middle flow passage pressure.

2. The apparatus of claim 1, wherein an inner circumference of said first opening of said first valve seat is flushed with soft material, and wherein said main body of said first rotary valve is dimensioned and configured to be between said first opening of said first valve seat and said upper flow passage.

3. The apparatus of claim 1, wherein an inner circumference of said second opening of said second valve seat is flushed with soft material, and wherein said main body of said second rotary valve is dimensioned and configured to be between said second opening of said second valve seat and said middle flow passage.

4. The apparatus of claim 1, wherein said first valve seat further comprises a first diaphragm made of flexible, resilient material, wherein said first diaphragm is in a ring-shape, wherein a first center opening is formed on said first diaphragm, wherein said first diaphragm covers said first opening, wherein said first center opening is coaxial with said first opening of said first valve seat, wherein said main body of said first rotary valve is dimensioned and configured to be between said first center opening and said upper flow passage, and wherein said first diaphragm can be deformed downwardly when said first rotary valve is disposed on said first diaphragm.

5. The apparatus of claim 1, wherein said second valve seat further comprises a second diaphragm made of flexible, resilient material, wherein said second diaphragm is in a ring-shape, wherein a second center opening is formed on said second diaphragm, wherein said second diaphragm covers said second opening, wherein said second center opening is coaxial with said second opening of said second valve seat, wherein said main body of said second rotary valve is dimensioned and configured to be between said second center opening and said middle flow passage, and wherein said second diaphragm can be deformed downwardly when said second rotary valve is disposed on second diaphragm.

6. The apparatus of claim 1, further comprises a first cage and a second cage, wherein a plurality of openings are formed on each of said first cage and said second cage, wherein said first cage is attached to said first valve seat, wherein said first rotary valve is disposed in said first cage, wherein said first rotary valve can move inside said first cage and above said first valve seat, wherein said second cage is attached to said second valve seat, wherein said second rotary valve is disposed in said second cage, and wherein said second rotary valve can move inside said second cage and above said second valve seat.

7. The apparatus of claim 1, further comprising an upper flow passage filter located in said upper flow passage and a lower flow passage filter located in said lower flow passage, and wherein said upper flow passage filter and lower flow passage filter have a predetermined sieve size to prevent a plurality of foreign objects from entering said housing.

8. The apparatus of claim 1, further comprising:
(a) two first guides mounted to said main body of said first rotary valve, wherein said two first guides are opposite to each other;
(b) two first guide rails, wherein said two first guide rails are disposed inside upper flow passage for guiding said first rotary valve between an open position and a closed position, wherein each of said two first guides of said first rotary valve are disposed in each of said two first guide rails, wherein said two first guides move freely in said two first guide rails, and wherein said two first guide rails are attached to said first valve seat;
(c) two second guides mounted to said main body of said second rotary valve, wherein said two second guides are opposite to each other; and
(d) two second guide rails, wherein said two second guide rails are disposed inside middle flow passage for guiding said second rotary valve between an open position and a closed position, wherein each of said two second guides of said second rotary valve are disposed in each of said two second guide rails, wherein said two second guides move freely in said two second guide rails, and wherein said two second guide rails are attached to said second valve seat.

9. The apparatus of claim 8, wherein said first rotary valve further comprises two turbulators, wherein each of said two turbulators comprises a plurality of impellers mounted to said main body of said first rotary valve, wherein said plurality of impellers are arranged in a circle around each of said two first guides of said first rotary valve, wherein each of said two turbulators are opposite to each other, wherein said two turbulators rotate said first rotary valve when said flow from said middle flow passage pushes said plurality of impellers, wherein said second rotary valve further comprises two turbulators, wherein each of said two turbulators comprises a plurality of impellers mounted to said main body of said second rotary valve, wherein said plurality of impellers are arranged in a circle around each of said two second guides of said second rotary valve, wherein each of said two turbulators are opposite to each other, and wherein said two turbulators rotate said second rotary valve when said flow from said lower flow passage pushes said plurality of impellers.

10. The apparatus of claim 8, wherein said first rotary valve further comprises two turbulators, wherein each of said two turbulators comprises a plurality of impellers radially mounted to each of said two first guides, wherein said two turbulators rotate said first rotary valve when said flow from said middle flow passage pushes said plurality of impellers, wherein said second rotary valve further comprises two turbulators, wherein each of said two turbulators comprises a plurality of impellers radially mounted to each of said two second guides, and wherein said two turbulators rotate said second rotary valve when said flow from said lower flow passage pushes said plurality of impellers.

11. The apparatus of claim 1, further comprising a pressure indicator, wherein said pressure indicator is responsive to said middle flow passage pressure, wherein said pressure indicator is visible on an external surface of said housing, and wherein said pressure indicator shows a pressure status of said middle flow passage pressure.

12. The apparatus of claim 11, further comprising a signal transmitter to transmit said pressure status of said pressure indicator.

13. The apparatus of claim 1, wherein said apparatus is configured to be inside said enclosed environment, wherein said enclosed environment has an ambient pressure in said enclosed environment, wherein said enclosed environment further comprises at least one conduit, wherein each said at least one conduit has a first end and a second end, wherein each of said at least one conduit has said first end connected to said lower flow passage of said apparatus and said second end extends out of said enclosed environment, and wherein said upper flow passage pressure is adapted to said ambient pressure of said enclosed environment.

14. The apparatus of claim 1, wherein said apparatus is configured to be outside said enclosed environment, wherein said enclosed environment has an ambient pressure in said enclosed environment, wherein said enclosed environment further comprises at least one conduit, wherein each said at least one conduit has a first end and a second end, wherein said first end is connected to said upper flow passage of said apparatus and said second end is connected to and communicated with said enclosed environment, and wherein said upper flow passage pressure is adapted to said ambient pressure of said enclosed environment.

15. The apparatus of claim 1, wherein said apparatus is installed in a piping system, wherein said upper flow passage of said apparatus is communicated with an upper elevation position of said piping system, wherein said lower flow passage is communicated with a lower elevation position of said piping system, wherein said second rotary valve is lifted away from said second valve seat when a flow moves from lower elevation position through said lower flow passage, wherein said first rotary valve is lifted away from said first valve seat when a flow moves from said middle flow passage through said first valve seat and into said upper flow passage, wherein said first rotary valve is disposed by gravity on said first valve seat when no flow passes through said first valve seat, and wherein said second rotary valve is disposed by gravity on said second valve seat when no flow passes through said second valve seat.

16. An apparatus to allow or stop a flow into an enclosed environment or piping system, comprising:
(a) a housing having an upper flow passage, a middle flow passage, a lower flow passage, wherein said upper flow passage is above said middle flow passage, wherein said middle flow passage is above said lower flow passage, wherein an upper flow passage pressure exists in said upper flow passage, wherein a middle flow passage pressure exists in said middle flow passage, and wherein a lower flow passage pressure exists in said lower flow passage;
(b) a first valve seat, wherein said first valve seat is between said upper flow passage and said middle flow passage, wherein a first opening is formed on said first valve seat, wherein said first opening has an inner diameter, wherein said first valve seat further comprises a first diaphragm made of flexible, resilient material, wherein said first diaphragm is in a ring-shape, wherein a first center opening is formed on said first diaphragm, wherein said first diaphragm covers said first opening, and wherein said first center opening is coaxial with said first opening of said first valve seat;
(c) a first rotary valve inside said housing, wherein said first rotary valve further comprises a main body, wherein said first rotary valve has a predetermined weight, wherein said first rotary valve can move inside said upper flow passage and above said first valve seat, wherein said first rotary valve is in an open position when said middle flow passage pressure is greater than said predetermined weight of said first rotary valve and said upper flow passage pressure, and wherein said first rotary valve is in an closed position when said middle flow passage pressure is equal to or less than said predetermined weight of said first rotary valve and said upper flow passage pressure, wherein said main body of said first rotary valve is dimensioned and configured to be between said first center opening and said upper flow passage, and wherein said first diaphragm can be deformed downwardly when said first rotary valve is disposed on said first diaphragm
(d) a second valve seat, wherein said second valve seat is between said middle flow passage and said lower flow passage, wherein a second opening is formed on said second valve seat, wherein said second opening has an inner diameter, and wherein an inner circumference of said second opening of said second valve seat is flushed with soft material;
(e) a second rotary valve inside said housing, wherein said second rotary valve further comprises a main body, wherein said second rotary valve has a predetermined weight, wherein said second rotary valve can move inside said middle flow passage and above said second valve seat, wherein said second rotary valve is in an open position when said lower flow passage pressure is greater than said predetermined weight of said second rotary valve and said middle flow passage pressure, wherein said second rotary valve is in an closed position when said lower flow passage pressure is equal to or less than said predetermined weight of said second rotary valve and said middle flow passage pressure, and wherein said main body of said second rotary valve is dimensioned and configured to be between said second opening of said second valve seat and said middle flow passage;
(f) two first guides mounted to said main body of said first rotary valve, wherein said two first guides are opposite to each other;
(g) two first guide rails, wherein said two first guide rails are disposed inside upper flow passage for guiding said first rotary valve between an open position and a closed position, wherein each of said two first guides of said first rotary valve are disposed in each of said two first guide rails, wherein said two first guides move freely in said two first guide rails, and wherein said two first guide rails are attached to said first valve seat;
(h) two second guides mounted to said main body of said second rotary valve, wherein said two second guides are opposite to each other;
(i) two second guide rails, wherein said two second guide rails are disposed inside middle flow passage for guiding said second rotary valve between an open position and a closed position, wherein each of said two second guides of said second rotary valve are disposed in each of said two second guide rails, wherein said two second guides move freely in said two second guide rails, and wherein said two second guide rails are attached to said second valve seat; and
(j) two turbulators, wherein each of said two turbulators comprises a plurality of impellers mounted to said main body of said first rotary valve, wherein said plurality of impellers are arranged in a circle around each of said two first guides of said first rotary valve, wherein each of said two turbulators are opposite to each other, wherein said two turbulators rotate said first rotary valve when said flow from said middle flow passage pushes said plurality of impellers, wherein said second rotary valve further comprises two turbulators, wherein each of said two turbulators comprises a plurality of impellers mounted to said main body of said second rotary valve, wherein said plurality of impellers are arranged in a circle around each of said two second guides of said second rotary valve, wherein each of said two turbulators are opposite to each other, and wherein said two turbulators rotate said second rotary valve when said flow from said lower flow passage pushes said plurality of impellers.

17. The apparatus of claim 16, further comprising an upper flow passage filter located in said upper flow passage and a lower flow passage filter located in said lower flow passage, and wherein said upper flow passage filter and lower flow passage filter have a predetermined sieve size to prevent a plurality of foreign objects from entering said housing.

18. The apparatus of claim 16, further comprising a pressure indicator, wherein said pressure indicator is responsive to said middle flow passage pressure, wherein said pressure indicator is visible on an external surface of said housing, and wherein said pressure indicator shows a pressure status of said middle flow passage pressure.

19. An apparatus to allow or stop a flow into an enclosed environment or piping system, comprising:
(a) a housing having an upper flow passage, a middle flow passage, a lower flow passage, wherein said upper flow passage is above said middle flow passage, wherein said middle flow passage is above said lower flow passage, wherein an upper flow passage pressure exists in said upper flow passage, wherein a middle flow passage pressure exists in said middle flow passage, and wherein a lower flow passage pressure exists in said lower flow passage;
(b) a first valve seat, wherein said first valve seat is between said upper flow passage and said middle flow passage, wherein a first opening is formed on said first valve seat, wherein said first opening has an inner diameter, and wherein an inner circumference of said first opening of said first valve seat is flushed with soft material;
(c) a first rotary valve inside said housing, wherein said first rotary valve further comprises a main body, wherein said first rotary valve has a predetermined weight, wherein said first rotary valve can move inside said upper flow passage and above said first valve seat, wherein said first rotary valve is in an open position when said middle flow passage pressure is greater than said predetermined weight of said first rotary valve and said upper flow passage pressure, wherein said first rotary valve is in an closed position when said middle flow passage pressure is equal to or less than said predetermined weight of said first rotary valve and said upper flow passage pressure, and wherein said main body of said first rotary valve is dimensioned and configured to be between said first opening of said first valve seat and said upper flow passage;
(d) a second valve seat, wherein said second valve seat is between said middle flow passage and said lower flow passage, wherein a second opening is formed on said second valve seat, wherein said second opening has an inner diameter, and wherein an inner circumference of said second opening of said second valve seat is flushed with soft material;
(e) a second rotary valve inside said housing, wherein said second rotary valve further comprises a main body, wherein said second rotary valve has a predetermined weight, wherein said second rotary valve can move inside said middle flow passage and above said second valve seat, wherein said second rotary valve is in an open position when said lower flow passage pressure is greater than said predetermined weight of said second rotary valve and said middle flow passage pressure, wherein said second rotary valve is in an closed position when said lower flow passage pressure is equal to or less than said predetermined weight of said second rotary valve and said middle flow passage pressure, and wherein said main body of said second rotary valve is dimensioned and configured to be between said second opening of said second valve seat and said middle flow passage;
(f) a first cage and a second cage, wherein a plurality of openings are formed on each of said first cage and said second cage, wherein said first cage is attached to said first valve seat, wherein said first rotary valve is disposed in said first cage, wherein said first rotary valve can move inside said first cage and above said first valve seat, wherein said second cage is attached to said second valve seat, wherein said second rotary valve is disposed in said second cage, and wherein said second rotary valve can move inside said second cage and above said second valve seat; and
(g) an upper flow passage filter located in said upper flow passage and a lower flow passage filter located in said lower flow passage, and wherein said upper flow passage filter and lower flow passage filter have a predetermined sieve size to prevent a plurality of foreign objects from entering said housing.

20. The apparatus of claim 19, further comprising a pressure indicator, wherein said pressure indicator is responsive to said middle flow passage pressure, wherein said pressure indicator is visible on an external surface of said housing, and wherein said pressure indicator shows a pressure status of said middle flow passage pressure.
